(19) United States
(12) Patent Application Publication
(10) Pub. No.: US 2024/0185623 A1
(43) Pub. Date: Jun. 6, 2024

(54) METHOD AND APPARATUS FOR PROVIDING TEXT INFORMATION INCLUDING TEXT EXTRACTED FROM CONTENT INCLUDING IMAGE

(71) Applicant: NAVER WEBTOON LTD., Seongnam-si (KR)

(72) Inventors: Seungseob YOON, Seongnam-si (KR); Junhyun PARK, Seongnam-si (KR); Jihoon LEE, Seongnam-si (KR); Hyo Jae KIM, Seongnam-si (KR); Jae Ho HYEON, Seongnam-si (KR); SeungTaek LIM, Seongnam-si (KR); Seungwook OH, Seongnam-si (KR); Kain CHOI, Seongnam-si (KR); Hyekyung KIM, Seongnam-si (KR); Sang Kuk LEE, Seongnam-si (KR); Taeyeong JANG, Seongnam-si (KR); SeungGeun OH, Seongnam-si (KR); TaeJong KANG, Seongnam-si (KR); Soon Hyong LEE, Seongnam-si (KR); Hyeong Gyu KIM, Seongnam-si (KR)

(21) Appl. No.: 18/525,135

(22) Filed: Nov. 30, 2023

(30) Foreign Application Priority Data
Dec. 1, 2022 (KR) 10-2022-0166066
Feb. 9, 2023 (KR) 10-2023-0017484

(51) Int. Cl. G06V 20/62; G06V 30/12; G06V 30/14; G06V 30/19; G06V 30/26

(52) U.S. Cl. CPC G06V 20/635; G06V 30/127; G06V 30/1448; G06V 30/1912; G06V 30/26; G06F 40/35

(57) ABSTRACT

A method of providing text information associated with content includes identifying content including an image uploaded to a content server, extracting text from the image included in the content, and providing text information including the extracted text as the text information associated with the content.

### CROSS-REFERENCE TO RELATED APPLICATION(S)

This U.S. non-provisional application claims the benefit of priority under 35 U.S.C. § 119 to Korean Patent Application No. 10-2022-0166066 filed on Dec. 1, 2022, and Korean Patent Application No. 10-2023-0017484 filed on Feb. 9, 2023, in the Korean Intellectual Property Office (KIPO), the entire contents of which are incorporated herein by reference.

### BACKGROUND OF THE INVENTION

### Field of Invention

One or more example embodiments of the present invention in the following description relate to a method and an apparatus for providing text information including text extracted from content including an image, and more particularly, to a method and an apparatus for extracting text corresponding to dialogue from content including a cut and dialogue, such as webcomic content, and providing text information including the corresponding text.

### Description of Related Art

Interest in services that provide online content having images, such as animations, cartoons, and webcomic services, is increasing. An image included in such content includes dialogue uttered by a character of the content for the progress of the story in the content or text for explaining the story and also includes text unrelated to the progress of the story. The text unrelated to the progress of the story is, for example, text included in sound effect, background decoration, or an object within the image and does not affect the progress of the story in the content, which differs from dialogue uttered by a character or text for explaining the story.

The text extracted from the content may be provided with the content as information associated with the content. For example, the text may be provided to an administrator in response to a request from the administrator that manages the content or may be provided to a consumer in response to a request from the consumer that consumes the content.

Here, the text provided in response to a request is required to be processed to effectively provide information related to the content, such as the storyline of the content, instead of simply listing all text extracted from the content as text information associated with the content. Also, when extracting the text from the content, text unrelated to the progress of the story may be excluded from extraction such that only meaningful text is included in the text information.

Korean Patent Registration No. 10-2374280 (registered on Mar. 10, 2022) describes a blocking system of text extracted from image and its method.

The aforementioned information is merely provided to assist understanding and may include contents that do not form a portion of the related art and may not include what the related art may present to those skilled in the art.

### BRIEF SUMMARY OF THE INVENTION

One or more example embodiments may identify content including an image uploaded to a content server, may extract text from the image included in the identified content, and may provide text information including the extracted text as text information associated with the content in response to a request from an administrator of the content or a consumer of the content.

One or more example embodiments may detect a plurality of cuts included in an image, may generate a cut image including each cut, may extract text from cut images corresponding to the plurality of cuts, may detect a dialogue area including dialogue in each cut image, may extract the text included in the dialogue area for each detected dialogue area using optical character recognition (OCR), and may generate text information based on the corresponding extracted text.

According to an aspect of at least one example embodiment, there is provided a method of providing text information associated with content, performed by a computer system, the method including identifying content including an image uploaded to a content server; extracting text from the image included in the content; and providing text information including the extracted text as text information associated with the content.

The image may include a plurality of cuts of the content in order and text including the dialogue of the content; the extracted text may be the dialogue extracted from the text included in the image; and the text information may include each line of a plurality of lines included in the dialogue and order information of each line.

The extracting of the text may include detecting the plurality of cuts in the image; generating each cut image including each cut of the plurality of cuts; and extracting text from cut images corresponding to the plurality of cuts.

The plurality of cuts may be included in the image in vertically scrolling order, and the each cut image may be configured to further include a blank area of a predetermined size above and below the each cut.

The extracting of the text from the cut images may include detecting a dialogue area including the dialogue for the each cut image; extracting text included in the dialogue area for each detected dialogue area using optical character recognition (OCR); and generating the text information based on the text extracted for each detected dialogue area, and the dialogue area may be an area including a speech bubble included in the image, an area including monologue or narration by an utterer (i.e., speaker) or a character of the content, or an area including explanatory text of the content, and the text information may include, as the order information, information regarding from which dialogue area and from which cut the text extracted for each detected dialogue area is extracted.

The order information may further include row information in a corresponding dialogue area of the text extracted for each detected dialogue area.

Each of the plurality of cuts may be assigned a first order number starting with the cut closest to the top in a vertical direction within the image and closest to the left or the right at the same location in the vertical direction; each dialogue area detected in the each cut image may be assigned a second order number starting with the dialogue closest to the top in the vertical direction within the each cut image and closest to the left or the right at the same location in the vertical direction; each line of the text extracted for each detected dialogue area may be assigned as the row information a third order number starting with the line closest to the top in the vertical direction; and the text information may include, as the order information, the first order number, the second order number, and the third order number for the text extracted from the each dialogue area.

The extracting of the text from the cut images may further include generating a virtual speech bubble corresponding to a first area or a second area when the detected dialogue area is the first area that includes the monologue or the narration or the second area that includes the explanatory text, and the order information may include information regarding from which speech bubble the text extracted for each detected dialogue area is extracted among speech bubbles based on a speech bubble corresponding to the detected dialogue area and order within the image of the speech bubbles including the virtual speech bubble.

The extracting of the text from the cut images may further include generating a single integrated dialogue area image by integrating dialogue areas detected in the cut images; and extracting text included in a corresponding dialogue area using OCR for each dialogue area, for the dialogue areas included in the integrated dialogue area image.

The detecting of the dialogue area may include detecting areas including text in the each cut image; identifying, from among the areas, a non-dialogue area that is an area including text corresponding to background of the each cut, text representing sound effect of the content, and text determined to be unrelated to the storyline of the content; and detecting areas excluding the non-dialogue area among the areas as a dialogue area including dialogue.

The providing may include providing the text information to an administrator terminal in response to a request from the administrator terminal that manages the content, and may further include providing a function that enables inspection of the text information for the administrator terminal, and the function that enables the inspection may include at least one of a first function capable of editing the text information, a second function capable of downloading the text information, and a third function for setting an update availability status of the text information.

The function that enables the inspection may include the first function, and the providing of the function that enables the inspection may include displaying the text information that includes a first cut selected by the administrator from among the plurality of cuts and dialogue extracted from the selected first cut on the administrator terminal; providing a first user interface for editing the displayed text information; and providing a second user interface for transition from the first cut to a second cut that is another cut among the plurality of cuts.

The providing may include providing audio information corresponding to the text information to a consumer terminal in response to a request from the consumer terminal that consumes the content.

The providing may include calling the text information associated with the content in response to a request from the consumer terminal for viewing the content; recognizing a cut that is being viewed by the consumer terminal among the plurality of cuts; and outputting audio information corresponding to a part corresponding to the recognized cut in the text information using the consumer terminal.

The method of providing the text information may further include monitoring an update status and a deletion status of the content for the content server; extracting text from the image included in the updated content when update of the content is identified; and deleting the text information associated with the content when deletion of the content is identified.

The method of providing the text information may further include determining an utterer of the content that utters the text extracted for each detected dialogue area, the utterer being determined based on at least one of an utterer image represented in association with a speech bubble corresponding to the detected dialogue area in the image and a color or a shape of the speech bubble corresponding to the detected dialogue area. Here, the text information generated based on the text extracted for each detected dialogue area may further include information on the determined utterer.

According to another aspect of at least one example embodiment, there is provided a computer system for providing text information associated with content, the computer system including at least one processor configured to execute instructions readable by the computer system. The at least one processor is configured to identify content including an image uploaded to a content server, to extract text from the image included in the content, and to provide text information including the extracted text as text information associated with the content.

According to some example embodiments, it is possible to exclude text corresponding to background of each cut included in content, text representing sound effect of the content, and text determined to be unrelated to the storyline of the content, and to provide text information including only text corresponding to the dialogue of the content to an administrator or a consumer of the content as text information associated with the content.

According to some example embodiments, an administrator may receive text information associated with content and may inspect and edit text extracted from each cut, and a consumer may receive audio information corresponding to the text information associated with the content being viewed when viewing the content.

According to some example embodiments, it is possible to detect a dialogue area in each cut image corresponding to each cut of content, to extract text for each detected dialogue area, and to process order information regarding from which dialogue area and from which cut the extracted text is extracted and to which row the extracted text belongs in a corresponding dialogue area as text information associated with the content with the extracted text.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an example of a method of extracting text from an image of content and providing text information including the extracted text according to at least one example embodiment;

FIG. 2 is a block diagram of an example of a computer system, a consumer terminal, and a content server to perform a method of providing text information according to at least one example embodiment;

FIG. 3 is a flowchart illustrating an example of a method of extracting text from an image of content and providing text information including the extracted text according to at least one example embodiment;

FIG. 4 is a flowchart illustrating an example of a method of extracting text from an image of content according to at least one example embodiment;

FIG. 5 is a flowchart illustrating an example of a method of generating an integrated dialogue area image by integrating dialogue areas extracted from cut image(s) and extracting text from the integrated dialogue area image according to at least one example embodiment;

FIG. 6 is a flowchart illustrating an example of a method of generating text information including extracted text and order information associated with the extracted text according to at least one example embodiment;

FIG. 7 is a flowchart illustrating an example of a method of detecting a dialogue area in a cut image according to at least one example embodiment;

FIG. 8 is a flowchart illustrating a method of providing text information associated with content to a consumer terminal of a consumer consuming the content according to at least one example embodiment;

FIG. 9 is a flowchart illustrating an example of a method of generating text information or deleting the text information by re-extracting text according to update or deletion of content according to at least one example embodiment;

FIG. 10A is a diagram illustrating an example of a cut image corresponding to a cut of content according to at least one example embodiment;

FIG. 10B is a diagram illustrating an example of a method of extracting a cut from an image of content according to at least one example embodiment;

FIG. 11A is a diagram illustrating an example of a method of detecting a dialogue area from a cut image according to at least one example embodiment;

FIG. 11B is a diagram illustrating an example of a method of detecting text from a dialogue area that is a speech bubble (or a virtual speech bubble) according to at least one example embodiment;

FIG. 12 is a diagram illustrating an example of a method of determining the order of cuts of content and a dialogue area included in each cut according to at least one example embodiment;

FIG. 13 is a diagram illustrating an example of a method of providing text information according to at least one example embodiment;

FIG. 14 is a table and

FIG. 15 is a diagram illustrating examples of a method of viewing and inspecting text information in an administrator terminal according to at least one example embodiment;

FIG. 16 illustrates an example of a method of providing audio information corresponding to text information to a consumer terminal according to at least one example embodiment;

FIG. 17 is a diagram illustrating an example of a method of extracting text from an image of content that is webcomic content and providing text information including the extracted text according to at least one example embodiment;

FIG. 18 is a diagram illustrating an example of a method of determining an utterer or a character that utters text included in a dialogue area according to at least one example embodiment; and

FIG. 19 is a diagram illustrating an example of an integrated dialogue area image according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flowcharts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

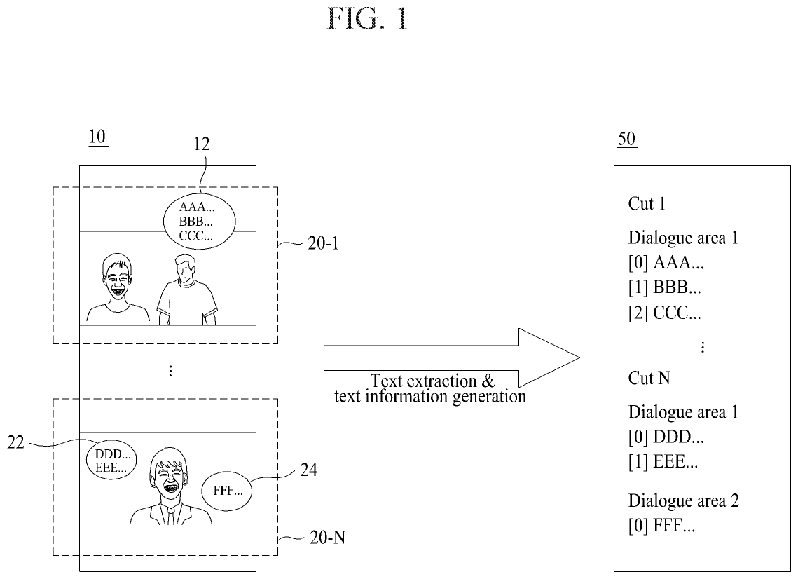

FIG. 1 illustrates an example of a method of extracting text from an image of content and providing text information including the extracted text according to at least one example embodiment.

A method of extracting text from content including an image 10 and generating and providing text information 50 including the extracted text is described with reference to FIG. 1.

The content is configured by including the image 10 and may be, for example, webcomic content. The webcomic content may include digital content-typed comics that is provided through the Internet based on a wired/wireless network.

The webcomic content may be read by a consumer in such a manner that the consumer (or reader) scrolls the corresponding webcomic content shown on a user terminal such as a smartphone or a person computer. The webcomic content includes a plurality of cuts, and the reader may view the webcomic content by sequentially verifying a plurality of cuts through scrolling. As used herein, a cut may indicate a minimal unit element for configuring webcomic or cartoon content including at least one image and/or dialogue section/region.

The content described herein may represent a single episode of a work that includes a plurality of episodes. For example, the content may represent a specific episode of a webcomic work.

The image 10 of FIG. 1 may be at least a portion of the content. The image 10 may include a plurality of cuts 20-1 to 20-N of the content in order and text including the dialogue of the content. The dialogue may include at least one word uttered by an utterer (i.e., speaker) (or character) included in the content. The dialogue may include monologue or narration by the utterer or the character of the content. Alternatively, the dialogue may include at least one word that explains the story in the content, instead of a word uttered by a specific utterer or character of the content. The word that explains the story in the content may be uttered by an author or a narrator of the content. The dialogue included in the image 10 may be acquired by excluding text unrelated to the progress of the story from the text included in the image 10.

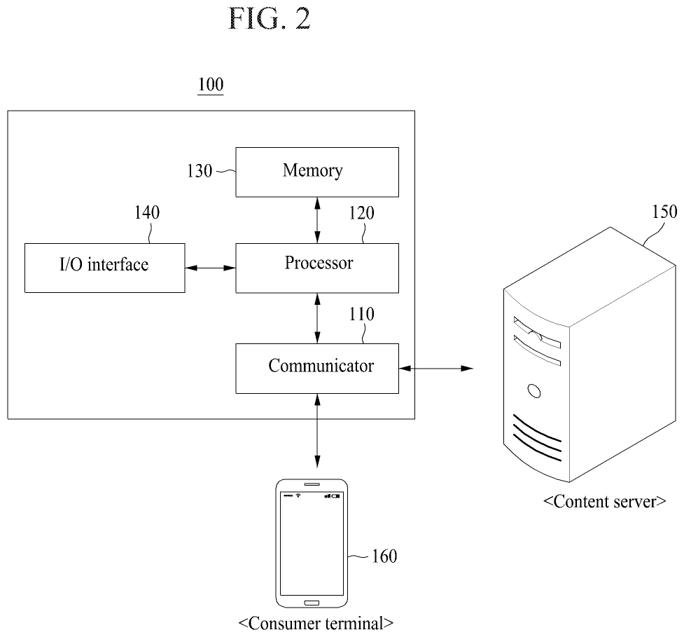

A computer system (e.g., a computer system 100 of FIG. 2) may extract text included in the image 10 from the image 10 of the content and may generate the text information 50 including the extracted text.

The text extracted from the image 10 may be acquired by extracting dialogue from the text included in the image 10. Therefore, the extracted text may include only text required to explain the story in the content. The computer system may detect dialogue areas 12, 22, and 24 including the dialogue in the image 10 and may extract text for each of the dialogue areas 12, 22, and 24. The computer system may detect the dialogue area(s) 12, 22, and/or 24 for each of the cuts 20-1 to 20-N and may extract the text for each of the dialogue areas 12, 22, and 24.

Referring to FIG. 1, the text information 50 generated by including the extracted text may include information indicating from which cut the extracted text is extracted (e.g., cut N, N denotes an integer), information indicating from which dialogue area the extracted text is extracted (e.g., dialogue area K, K denotes an integer), and information indicating to which row a line of the extracted text corresponds (e.g., [R], R denotes an integer). As described above, the text information 50 may include the extracted text and order information associated with the extracted text. That is, the text information 50 may include each line of a plurality of lines included in the dialogue of the content and order information of each corresponding line.

The text information 50 is configured to include meaningful text that explains the story in the content and may be provided to the administrator that manages the content. The administrator may use the text information 50 to service the content to the consumer. For example, when viewing the content, the consumer of the content may be provided with audio information corresponding to the text information 50 in response to a request.

A method of extracting, by the computer system, text from the image 10 of the content and generating and providing the text information 50 including the extracted text is further described with reference to FIGS. 2 to 19.

FIG. 2 illustrates an example of a computer system, a consumer terminal, and a content server to perform a method of providing text information according to at least one example embodiment.

The computer system 100 may be a computing device that performs a task required to perform the method of providing text information of the example embodiment.

The computer system 100 may be configured to include at least one computing device. The computer system 100 may detect the dialogue area 12, 22, 24 in the image 10 included in the content, may extract text included in the dialogue area 12, 22, 24, may generate the text information 50 including the extracted text, and may provide the generated text information 50 to an administrator terminal (not shown) that manages the content or a consumer terminal 160 that consumes the content.

The computer system 100 may be the aforementioned administrator terminal or may be another computer device or a server that communicates with the administrator terminal. The administrator terminal may provide a tool for viewing or investigating the provided text information 50.

Further, the computer system 100 may identify the content uploaded to a content server 150 and may perform the aforementioned text extraction and providing of the text information 50.

The content server 150 refers to a server in which the content is managed. The content may be uploaded to the content server 150 and the uploaded content may be updated or deleted. The content server 150 may be a service platform that provides the content, for example, webcomic content, or a portion of the service platform.

Hereinafter, a configuration of the computer system 100 is further described.

Referring to FIG. 2, the computer system 100 may include a memory 130, a processor 120, a communicator 110, and an input/output (I/O) interface 140.

The memory 130 may include a permanent mass storage device, such as random access memory (RAM), read only memory (ROM), and a disk drive, as a non-transitory computer-readable recording medium. Here, ROM and the permanent mass storage device may be included as a permanent storage device separate from the memory 130. Also, an operating system (OS) and at least one program code may be stored in the memory 130. Such software components may be loaded from another non-transitory computer-readable recording medium separate from the memory 130. The other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 130 through the communicator 110, instead of the non-transitory computer-readable recording medium.

The processor 120 may be configured to process instructions of a computer program by performing basic arithmetic operations, logic operations, and I/O operations. The computer-readable instructions may be provided from the memory 130 or the communicator 110 to the processor 120. For example, the processor 120 may be configured to execute received instructions in response to the program code stored in the memory 130.

The communicator 110 may be a component for communication between the computer system 100 and another apparatus (e.g., user terminal or another server). That is, the communicator 110 may be a hardware module, such as an antenna, a data bus, a network interface card, a network interface chip, and a networking interface port of the computer system 100, or a software module, such as a network device driver or a networking program, configured to transmit/receive data and/or information to/from another apparatus.

The I/O interface 140 may be a device used for interfacing with an input device, such as a keyboard, a mouse, etc., and an output device, such as a display, a speaker, etc.

The processor 120 may manage components of the computer system 100, may execute a program or an application for performing the aforementioned detection of the dialogue area 12, 22, 24 in the image 10 of the content, text extraction for each dialogue area 12, 22, 24, and generation and providing of the text information 50, and may process an operation required for executing the program or the application and processing data. The processor 120 may be at least one processor (central processing unit (CPU) or graphics processing unit (GPU)) of the computer system 100 or may be at least one core in the processor.

Also, in some example embodiments, the computer system 100 and the processor 120 may include greater or smaller number of components than the number of components shown in FIG. 2. For example, the processor 120 may include components configured to perform functions of training a transformation model and performing an image transformation method of an example embodiment using the trained transformation model. The components of the processor 120 may be a physical portion of the processor 120 or a function implemented by the processor 120. The components included in the processor 120 may be representations of different functions performed by the processor 120 in response to a control instruction according to a code of an OS or a code of at least one computer program.

The illustrated consumer terminal 160 may be a user terminal of the consumer that views the content. The user terminal may be a smart device such as a smartphone, a personal computer (PC), a laptop computer, a tablet, an Internet of things (IOT) device, or a wearable computer. Also, the consumer terminal 160 may be any type of electronic devices (e.g., an E-book reader) that allows viewing of the content, for example, webcomic content.

As described above, the content server 150 may be a service platform that provides the content or a portion of the service platform. Depending on example embodiments, the content server 150 may include the computer system 100, or the computer system 100 may include the content server 150.

The consumer terminal 160 and the content server 150 may refer to the computer system 100 and may include components similar to those of the computer system 100 and thus, repeated description is omitted.

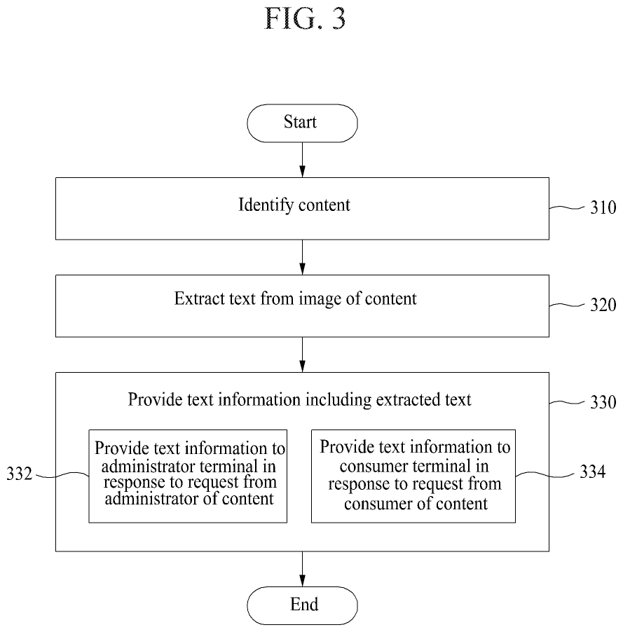

A method of providing the text information 50 associated with content through the computer system 100 and an operation of the computer system 100, the consumer terminal 160, and the content server 150 will be further described with reference to FIGS. 3 to 19.

In the following description, an operation performed by the computer system 100 or the processor 120 or components thereof may be explained as an operation performed by the computer system 100 for convenience of description.

FIG. 3 is a flowchart illustrating an example of a method of extracting text from an image of content and providing text information including the extracted text according to at least one example embodiment.

In operation 310, the computer system 100 (or the processor 120) may identify content including the image 10 that is a target for generating the text information 50. For example, the computer system 100 may identify the content including the image 10 uploaded to the content server 150. The computer system 100 may monitor the content server 150 periodically (e.g., every 1 hour) and, when the content including the image 10 is uploaded to the content server 150 or when update of the content including the uploaded image 10 is identified, may identify the corresponding content as a target for generating the text information 50. Alternatively, the computer system 100 may receive a notification from the content server 150 that the content including the image 10 is uploaded (or updated) and accordingly, may identify the content including the uploaded (or updated) image 10.

In operation 320, the computer system 100 (or the processor 120) may extract text from the image 10 included in the content. For example, the computer system 100 may extract the text from the image 10 using OCR. As described above, the image 10 may include a plurality of cuts of the content in order and text including the dialogue of the content, as at least a portion of webcomic content. Here, the computer system 100 may extract the dialogue from the text included in the image 10. The computer system 100 may extract a cut and a dialogue area from the image 10 and may extract the dialogue from the image 10 using a learning model pretrained to extract the text from the dialogue area. In one embodiment, the OCR and the learning model may be functions performed by the processor 120 in response to control instructions provided by at least one corresponding program code stored in the memory 130.

The computer system 100 may generate the text information 50 that includes the extracted text. For example, the computer system 100 may generate the text information 50 that processes and includes the extracted text to include order information. The order information included in the text information 50 may include, for example, information indicating from which cut the extracted text is extracted (e.g., cut N, N denotes an integer), information indicating from which dialogue area the extracted text is extracted (e.g., dialogue area K, K denotes an integer), and information indicating to which row a line of the extracted text corresponds (e.g., [R], R denotes an integer).

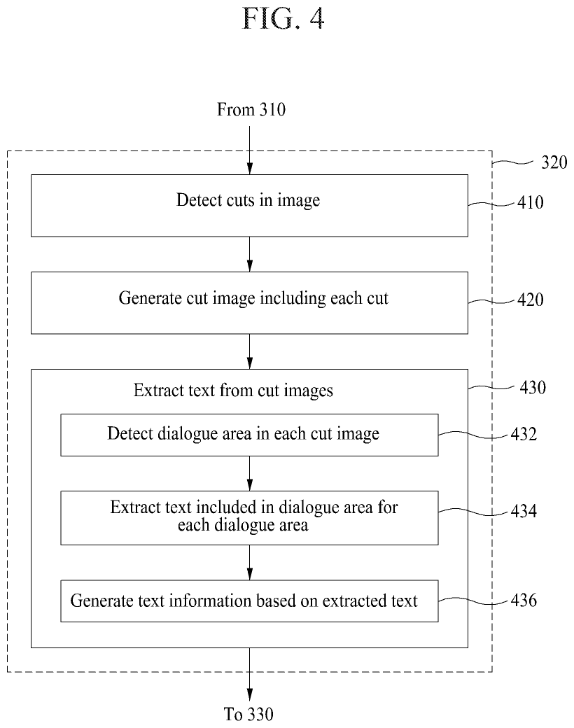

A method of extracting text from the image 10 is further described with reference to FIGS. 4 to 7 and FIGS. 10 and 11.

In operation 330, the computer system 100 (or the processor 120) may provide the text information 50 including the text extracted in operation 320 as the text information 50 associated with the content.

For example, in operation 332, in response to a request from an administrator terminal that manages the content, the computer system 100 may provide the text information 50 to the administrator terminal. The administrator terminal may provide a tool for viewing and inspecting the provided text information 50.

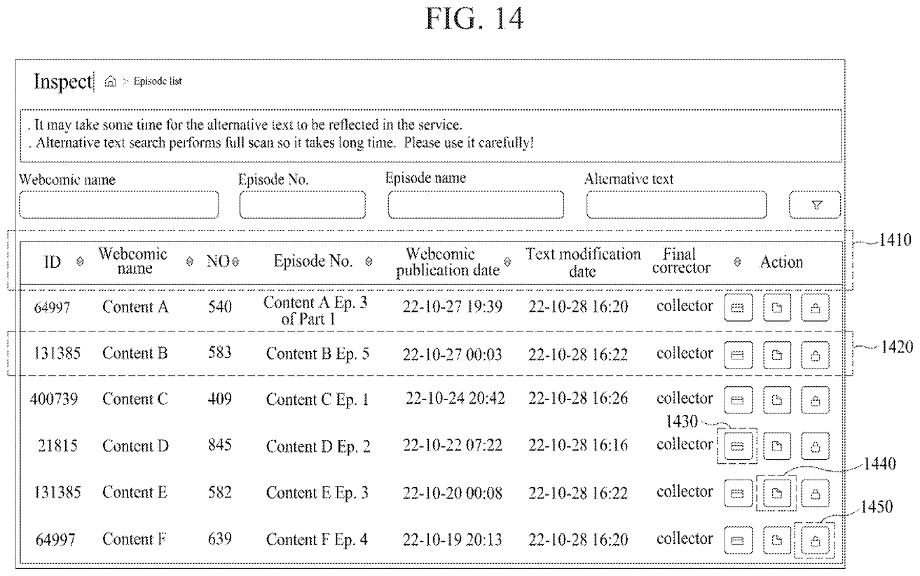

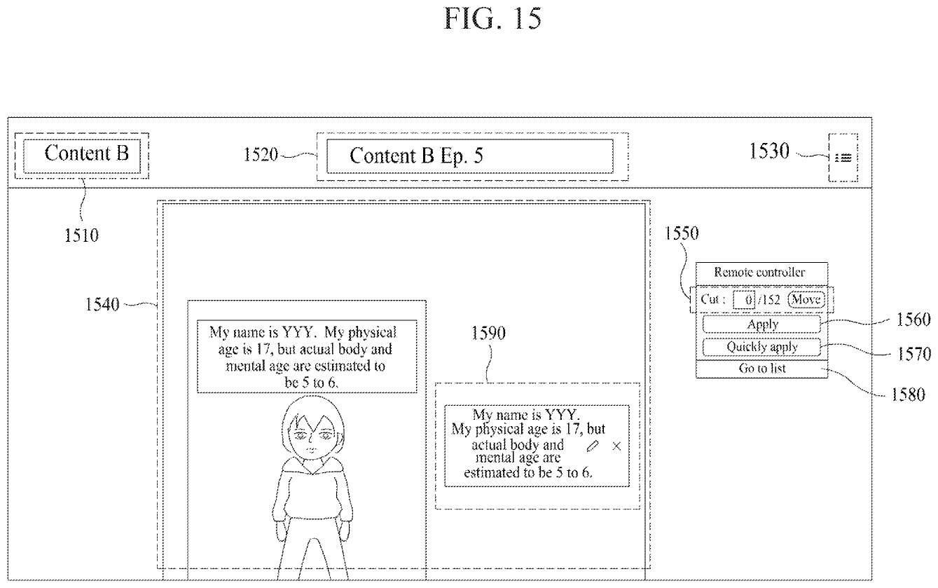

In this regard, FIGS. 14 and 15 illustrate examples of a method of viewing and inspecting text information in an administrator terminal according to at least one example embodiment.

FIGS. 14 and 15 illustrate examples of a screen of the administrator terminal for displaying the tool for viewing and inspecting the text information 50.

The computer system 100 may provide a function that enables inspection of the text information 50 for the administrator terminal.

FIG. 14 illustrates a list of the text information 50 in the tool for viewing and inspecting the text information 50. Referring to FIG. 14, the text information 50 may be sorted according to a predetermined criterion (e.g., ID, content name, number, episode name, content publication date, text information modification date, text information corrector, etc.) through a first user interface (UI) 1410. In response to a selection on one piece of text information 1420 from the list, the administrator terminal may make a transition to a screen for inspecting the corresponding text information 1420. For example, the administrator terminal may make a transition to a screen as illustrated in FIG. 15.

The tool for viewing and inspecting the text information 50 may include, as the function that enables inspection of the text information 50, a first function 1430 capable of editing the text information 50, a second function 1440 capable of downloading the text information 50, and a third function 1450 for setting an update availability status of the text information 50.

For example, in response to a selection on the first function 1430, the administrator terminal may make a transition to a screen for inspecting the corresponding text information 50. For example, the administrator terminal may make a transition to the screen as illustrated in FIG. 15.

Through the second function 1440, the text information 50 may be downloaded to the administrator terminal in a form of, for example, an excel file.

If the third function 1450 is set to be ON, update of the text information 50 may be disallowed. If the third function 1450 is set to be ON, the text information 50 may not be modified or deleted although the content is updated or deleted. A default value may be that the third function 1450 is set to be OFF.

In the following, a method of inspecting the text information 50 is further described with reference to FIG. 15. In FIG. 15, the text information 1590 is selected from the text information list.

Referring to FIG. 15, the administrator terminal may display a work name 1510 of content and an episode name 1520 of the content. In response to a selection on a button 1530, an episode list of a corresponding work may be called. The administrator may inspect the text information 1590 of another episode of the same work through the episode list.

A cut image area 1540 may be displayed on an inspection screen. The cut image area 1540 may include the text information 1590 including a selected cut of the content and text extracted from the corresponding cut and a cut number (‘0’). The text information 1590 may be configured to be editable by an administrator. Therefore, the text information 1590 may modify the text erroneously extracted by the computer system 100. A remote controller UI may be further displayed on the inspection screen. The remote controller UI may include a UI 1550 for moving to another cut (that enables the administrator to directly input a cut number), a UI 1560 for applying the modified text information 1590, a UI 1570 for applying the modified text information 1590 to a service more quickly (e.g., with top priority), and a UI 1580 for moving to an episode list.

The aforementioned function and UI of the tool for viewing and inspecting the text information 1590 may be provided to the administrator terminal under the control of the computer system 100.

That is, the computer system 100 may display the text information 1590 including a first cut (‘0’) selected by the administrator from among the plurality of cuts of the content and dialogue extracted from the corresponding first cut (‘0’) on the administrator terminal. Here, a user interface for editing the displayed text information 1590 may be provided to the administrator terminal. Also, the computer system 100 may further provide a user interface 1550 that enables transition from the first cut (‘0’) to a second cut that is another cut among the plurality of cuts.

As described above, in the example embodiment, the administrator may inspect the text information 50 generated and provided by the computer system 100 using the tool through the administrator terminal and the inspected text information 50 may be applied to a service for providing the content.

Also, in operation 334, the computer system 100 may provide the text information 50 to the consumer terminal 160 in response to a request from the consumer terminal 160 that consumes the content.

For example, in response to a request from the consumer terminal 160 that consumes the content, the computer system 100 may provide audio information corresponding to the text information 50 to the consumer terminal 160. The audio information may be acquired by converting text included in the text information 50 to audio. For example, the text included in the text information 50 may be converted to audio using text-to-speech (TTS) technology.

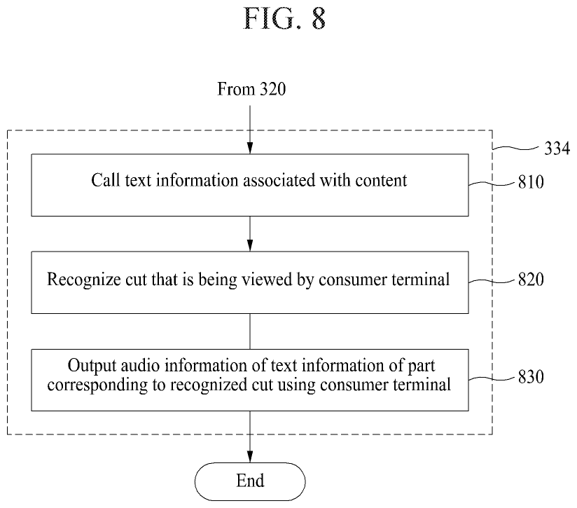

In this regard, FIG. 8 is a flowchart illustrating a method of providing text information associated with content to a consumer terminal of a consumer consuming the content according to at least one example embodiment.

In an example embodiment, the consumer terminal 160 that views content may be provided with audio information in which text extracted from the image 10 is converted to audio based on the text information 50. This provision of the audio information to the consumer terminal 160 may be a provision of a service for reading the dialogue of the content.

In operation 810, the computer system 100 (or the processor 120) may call the text information 50 associated with content in response to a request from the consumer terminal 160 for viewing the content. For example, the consumer terminal 160 may view the content through a ‘webcomic application’ that is a dedicated application for viewing the webcomic content and accordingly, the computer system 100 (or the content server 150) may call the text information 50. In other words, the computer system 100 may retrieve the text information 50 extracted, generated and stored by performing the operations described with respect to FIGS. 3-7.

In operation 820, the computer system 100 or the processor 120 (or the content server 150) may recognize a cut that is being viewed by the consumer terminal 160 among the plurality of cuts of the content. For example, the computer system 100 (or the content server 150) may recognize the cut of the content displayed on a screen of the consumer terminal 160 or may recognize a selection (or a touch) by a user on the cut of the content displayed on the screen of the consumer terminal 160. Alternatively, when the cut of the content is displayed at a specific location (e.g., central area) on the screen of the consumer terminal 160, the computer system 100 (or the content server 150) may recognize the corresponding cut.

In operation 830, the computer system 100 or the processor 120 (or the content server 150) may output audio information corresponding to a part corresponding to the recognized cut in the text information 50 using the consumer terminal 160. That is, the consumer terminal 160 may output audio that reads dialogue corresponding to a content cut being displayed.

If the corresponding cut is not displayed on the consumer terminal 160 or deviates from the specific location (e.g., central area) by a predetermined value or more, output of the audio may be suspended.

Also, depending on example embodiments, a “reader function” may be selected and initially executed on the consumer terminal 160 and accordingly, the aforementioned operations 820 and 830 may be performed. A cut transition in the consumer terminal 160 may be automatically performed.

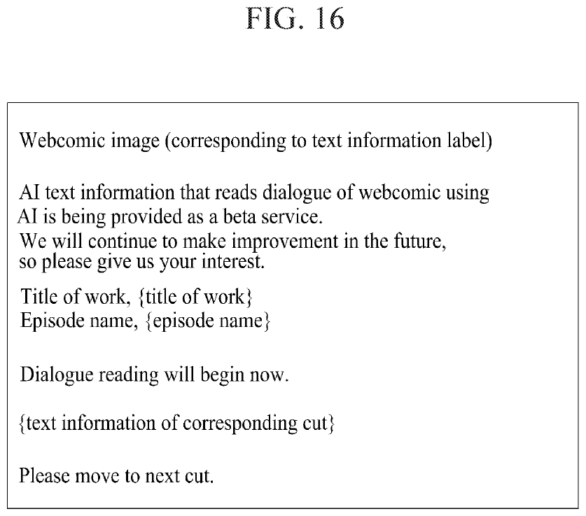

In this regard, FIG. 16 illustrates an example of a method of providing audio information corresponding to text information to a consumer terminal according to at least one example embodiment.

FIG. 16 illustrates audio information output using the consumer terminal 160 when a first cut of content is recognized (or when the “reader function” is executed and the first cut is displayed on the consumer terminal 160). As illustrated, prior to reading text extracted from a cut, a guidance phrase (“Please use AI to . . . ”; “Reading of lines will now begin.”) and “title of the work” and “episode name” of the corresponding work may be output first using voice. After audio information corresponding to the text in the recognized cut is output, a guidance phrase such as “Please move to a next cut” may be output using voice.

As described above with reference to FIGS. 14 and 15, the text information 50 may be inspected for provision of a service by being provided to the administrator terminal. The inspected text information 50 may be serviced to the consumer terminal 160 that views the content as described above with reference to FIGS. 8 and 16.

Description related to technical features made above with reference to FIGS. 1 and 2 may apply as is to FIG. 3, FIG. 8, and FIGS. 14 to 16 and thus, repeated description is omitted.

FIG. 4 is a flowchart illustrating an example of a method of extracting text from an image of content according to at least one example embodiment.

The computer system 100 may extract a cut and a dialogue area from the image 10 and may extract dialogue from the image 10 using a learning model pretrained to extract the text from the dialogue area.

The learning model may refer to an artificial intelligence (AI) model, for example, an artificial neural network or deep learning-based model. The learning model may be pretrained to extract a cut from the image 10 of content, such as webcomic content, and also may be pretrained to extract, from each cut, text corresponding to dialogue in text included in each cut. For example, the learning model may be pretrained to extract a dialogue area including dialogue from each cut and to extract text from the detected dialogue area. For example, operations to be described below with reference to FIGS. 4 to 7 may be performed using the learning model.

In operation 410, the computer system 100 (or the processor 120) may detect a plurality of cuts in the image 10 of the content.

In operation 420, the computer system 100 (or the processor 120) may generate each cut image including each cut of the plurality of cuts. The computer system 100 may detect cuts in the image 10 using the pretrained learning model and may generate the cut image configured to include each cut. The learning model may be trained to generate the cut image from the image 10. For example, in the case of the image 10 of webcomic content, cuts may be divided into rectangular areas and the like and the computer system 100 may detect the plurality of cuts of the content by recognizing such divided cuts.

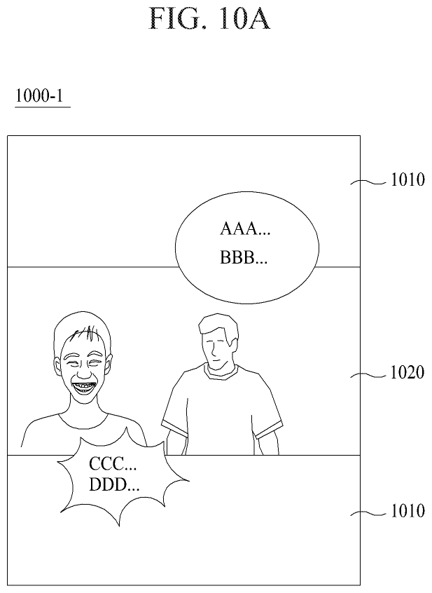

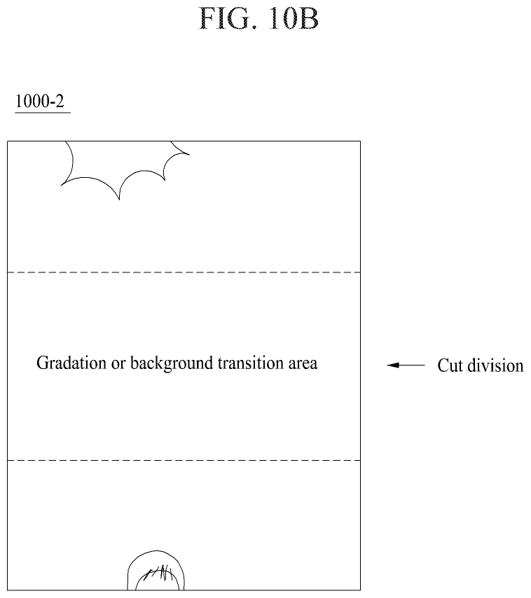

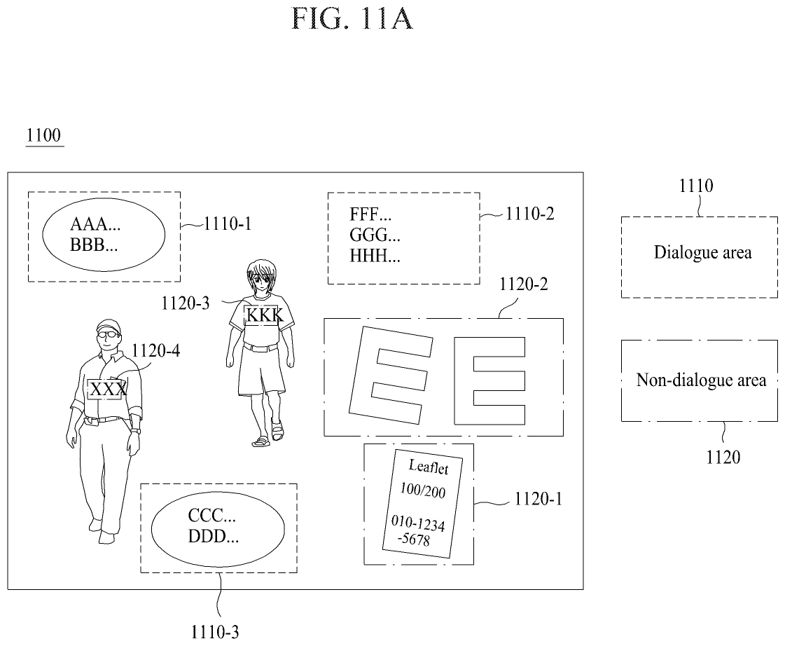

In this regard, FIG. 10A illustrates an example of a cut image corresponding to a cut of content according to at least one example embodiment.

In the illustrated example, the plurality of cuts included in the image 10 of the content may be included in the image 10 in vertically scrolling order. Here, each cut image configured by including each cut may be configured to further include blank areas 1010 of a predetermined size above and below each cut.

Referring to FIG. 10A, a cut image 1000-1 may include a cut area 1020 corresponding to a cut and the blank areas 1010 around the cut area 1020. Depending on example embodiments, the blank areas 1010 may be present on the left and the right of the cut area 1020 as well as above and below the cut area 1020.

The computer system 100 may generate the cut image 1000-1 to include the blank areas 1010 around the cut area 1020, such that a dialogue area (or speech bubble) present across border of each cut may be sufficiently included in the cut image 1000-1.

That is, the computer system 100 may detect the plurality of cuts in the image 10, may allow a cut image to include the blank area 1010 between cuts when dividing or cropping the image 10 to generate the cut image to include each cut, and may prevent a dialogue area or a speech bubble present across a cut line between cuts from being missed from the cut image.

For example, the blank area 1010 included in the cut image 1000-1 may have a predetermined size. Alternatively, a first cut image may be generated by cutting the blank area in the middle between a cut line of a first cut area and a cut line of a second cut area that is the next cut of the first cut area and the blank area in the middle between the cut line of the first cut area and a cut line of a zeroth cut area that is a previous cut of the first cut area. Here, the cut image may have a different size according to the blank area between cut areas.

In some instances, a cut may not be divided into rectangular areas depending on content. In this regard, FIG. 10B illustrates an example of a method of extracting a cut from an image of content according to at least one example embodiment.

Referring to FIG. 10B, cuts may be divided by gradation, solid background, or other background transition effect, without being divided by a visually recognizable cut line. Even in this case, the aforementioned learning model may be configured to detect a cut in the image 10 and to generate a cut image. For example, the computer system 100 may determine the middle of a gradient area between cuts as boundary of a cut image. Alternatively, when gradation or solid color with a predetermined length or more is present within the image 10, the computer system 100 may determine the boundary of the cut image based on the gradation or the solid color. For example, when gradation or solid color with a predetermined length or more is present within the image 10, the computer system 100 may determine the middle thereof as the boundary of the cut image. Gradation or solid color with the predetermined length or more may be treated in a similar manner to the blank area 1010.

The computer system 100 may assign order to the extracted cut or the cut image including the corresponding cut according to the order of the corresponding cut. For example, the computer system 100 may assign an order number to the extracted cut or the cut image including the corresponding cut. This order or order number may be used as order information included in the text information 50.

In one embodiment, the computer system 100 may extract an area including only a speech bubble or a dialogue area as a cut according to a composition of the image 10 of the content. For example, only a speech bubble or a dialogue area may be present in a specific area and a predetermined area therearound (above and below) may be gradient or solid color. Here, the computer system 100 may extract an area in which only the speech bubble or the dialogue area is present as a cut. This cut does not include a cut line. When an area including only a speech bubble or a dialogue area is extracted as a cut, the computer system 100 may generate a virtual cut line. Similar to other cuts, order may be assigned to the cut that includes the virtual cut line. That is, similar to a cut or a cut image that includes a real cut line, an order number may be assigned to the cut or the cut image that includes the virtual cut line. In one embodiment, The computer system 100 may determine where the virtual cut line should be by determining the blank area before or after the speech bubble or the dialogue area.

In operation 430, the computer system 100 (or the processor 120) may extract text from cut images corresponding to the plurality of cuts. The computer system 100 may extract the text from the cut images using the pretrained learning model. For example, the learning model may be trained to detect a dialogue area including dialogue from a cut image, and the computer system 100 may extract text using OCR from the dialogue area detected using the learning model.

Hereinafter, a method of detecting a dialogue area in a cut image and extracting text from the dialogue area is further describe with reference to operations 432 to 436.

In operation 432, the computer system 100 may detect a dialogue area including dialogue of content for each cut image. The computer system 100 may detect the dialogue area in each cut image using the pretrained learning model.

The dialogue area may be a speech bubble included in the image 10 of the content, an area including monologue or narration by an utterer or a character of the content (i.e., an area not classified into text or a speech bubble uttered by the utterer or the character), or an area including explanatory text of the content (an area not classified into a speech bubble, for example, text uttered by an author). Here, the utterer or the character may be a person that appears in the content. The learning model may be pretrained to detect the dialogue area in the cut image and may be pretrained using images including cuts included in a plurality of pieces of webcomic content.

Text included in the dialogue area may be regarded as text required to explain the story in the content.

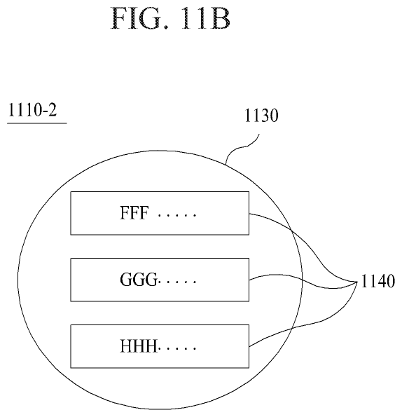

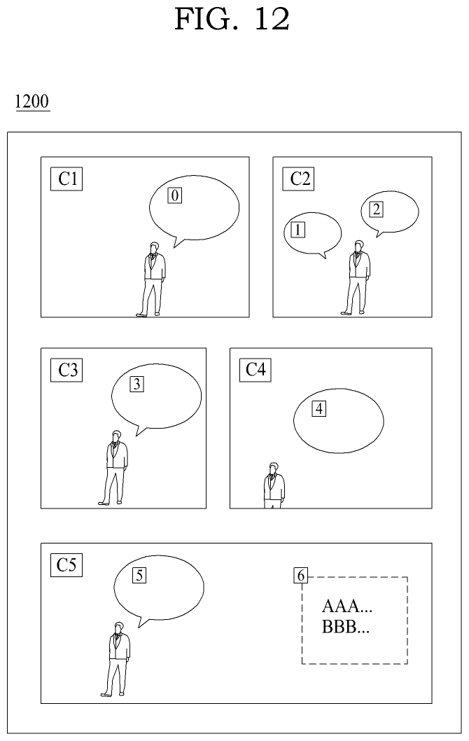

In this regard, FIG. 11A illustrates an example of a method of detecting a dialogue area in a cut image according to at least one example embodiment.

FIG. 11A illustrates a cut image 1100. The computer system 100 may detect a dialogue area 1110 in the cut image 1100. The dialogue area 1110 may include a first dialogue area 1110-1 and a third dialogue area 1110-3 each representing a speech bubble and a second dialogue area 1110-2 that is a dialogue area not classified into a speech bubble. The second dialogue area 1110-2 may be the aforementioned area including monologue or narration by the utterer or the character of the content or explanatory text of the content.

The computer system 100 may detect dialogue areas including the first dialogue area 1110-1 and the third dialogue area 1110-3 as dialogue areas representing speech bubbles present in various shapes using the pretrained learning model. Also, using the pretrained learning model, the computer system 100 may include the second dialogue area 1110-2 that is a dialogue area including dialogue not classified into the speech bubble. The learning model may be trained to detect the second dialogue area 1110-2 including the dialogue (not text unrelated to sound effect or storytelling) in consideration of a location of a corresponding dialogue area, a length of text included in the dialogue area, a size of the text, and a font of the text.

Further, the computer system 100 may identify a non-dialogue area 1120 that does not include dialogue from the text included in the cut image 1100. The non-dialogue area 1120 may include, for example, an area including text included in an object (e.g., character, etc.) within the cut image 1100 (e.g., a first non-dialogue area 1120-1, a third non-dialogue area 1120-3, and a fourth non-dialogue area 1120-4). Also, the non-dialogue area 1120 may include, for example, an area including a pattern or text included in background of a cut (e.g., a second non-dialogue area 1120-2). For example, an area including text corresponding to sound effect included in the cut image 1100 may be identified as the non-dialogue area 1120. The sound effect may be text representation of sound, effect, etc., generated according to a movement of an object included in the content.

In an example embodiment, for example, text included in an object, such as a leaflet, is text unrelated to storytelling of the content and an area including the corresponding text may be identified as the first non-dialogue area 1120-1. Also, text included in clothes of a character is text unrelated to storytelling of the content and an area including the corresponding text may be identified as the third non-dialogue area 1120-3 and the fourth non-dialogue area 1120-4. Also, a pattern or text represented using the background of a cut is also text unrelated to the story telling of the content and an area including the corresponding pattern or text may be identified as the second non-dialogue area 1120-2.

In an example embodiment, the computer system 100 may exclude the non-dialogue area 1120 and may detect only the dialogue areas 1110 from among areas including text.

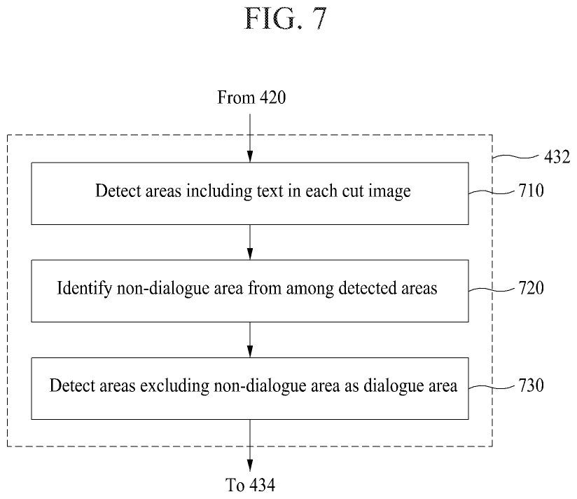

In this regard, FIG. 7 is a flowchart illustrating an example of a method of detecting a dialogue area in a cut image according to at least one example embodiment.

When detecting a dialogue area in the cut image 1100, the computer system 100 (or the processor 120) may detect areas including text in each cut image 1100 in operation 710. The detected areas may include the dialogue area 1110 and the non-dialogue area 1120.

In operation 720, the computer system 100 (or the processor 120) may identify, from among the detected areas, the non-dialogue area 1120 that is an area including text corresponding to background of each cut (i.e., a pattern or text represented in the background), text representing the sound effect of the content, and text determined to be unrelated to the storyline of the content (e.g., the aforementioned text included in the first to the fourth non-dialogue area 1120-1 to 1120-4).

In operation 730, the computer system 100 (or the processor 120) may detect areas excluding the identified non-dialogue area 1120 from among the areas as the dialogue area 1110 including the dialogue. The aforementioned learning model for identifying the dialogue area 1110 may be pretrained to distinguish between the dialogue area 1110 and the non-dialogue area 1120.

Depending on example embodiments, unlike what is described through operations 720 and 730, the computer system 100 may also immediately detect the dialogue area 1110 from among the areas detected in operation 710, without identifying the non-dialogue area 1120.

Hereinafter, a method of extracting text from the detected dialogue area is further described.

In operation 434, the computer system 100 may extract text included in a dialogue area for each detected dialogue area using OCR. That is, the computer system 100 may extract text for each dialogue area. Since text included in a corresponding dialogue area is extracted for each dialogue area, it is possible to prevent text that is not included in one dialogue area but included in the same line of a cut image (or text included in another dialogue area present in the same line) from being erroneously recognized using OCR. Dialogue included in one dialogue area constitutes dialogue that forms a single meaning or message. Therefore, text included in a dialogue area is extracted for each dialogue area and the extracted text may more accurately explain the story in the content. That is, the accuracy of order of dialogue represented by text may be guaranteed by extracting the text included in the dialogue area for each dialogue area.

In this regard, FIG. 11B illustrates an example of a method of detecting text from a dialogue area that is a speech bubble (or a virtual speech bubble) according to at least one example embodiment.

Referring to FIG. 11B, text may be extracted through OCR for the recognized second dialogue area 1110-2. The illustrated second dialogue area 1110-2 may include a total of three lines 1140, FFF . . . , GGG . . . , HHH . . . . Each of the extracted lines of the text may be associated with order information indicating to which row each line corresponds in the corresponding second dialogue area 1110-2. Therefore, the text information 50 may include this order information.

Text may be extracted in a similar manner for the first dialogue area 1110-1 and the third dialogue area 1110-3 that are distinguished using a speech bubble.

The second dialogue area 1110-2 in the illustrated example may be a dialogue area corresponding to a first area including a monologue or narration or a second area including explanatory text of the content. The computer system 100 may generate a virtual speech bubble 1130 corresponding to the first area or the second area, for the first area or the second area. The virtual speech bubble 1130 may be generated to assign the order information for the dialogue area.

That is, the order information included in the text information 50 to be described below may include information regarding from which speech bubble the text extracted for each detected dialogue area is extracted among speech bubbles, based on the order within the image 10 of speech bubbles that include a speech bubble corresponding to the detected dialogue area and a virtual speech bubble. That is, an order number of a dialogue area included in the order information may be sequentially assigned to all of a dialogue area classified into a speech bubble and a dialogue area not classified into a speech bubble.

In operation 436, the computer system 100 may generate the text information 50 based on the text extracted for each detected dialogue area.

The text information 50 may include, as the order information, information regarding from which dialogue area and from which cut the text extracted for each detected dialogue area is extracted. Also, the order information may be configured to further include row information within a corresponding dialogue area of the text extracted for each detected dialogue area.

For example, the order information included in the text information 50 may include information indicating from which cut the extracted text is extracted (e.g., cut N, N denotes an integer), information indicating from which dialogue area the extracted text is extracted (e.g., dialogue area K, K denotes an integer), and information indicating to which row a line of the extracted text corresponds (e.g., [R], R denotes an integer).

For example, each of the plurality of cuts of the image 10 of the content may be assigned a first order number starting with the cut closest to the top in a vertical direction within the image 10 and closest to the left or the right at the same location in the vertical direction.

Also, each dialogue area detected in each cut image may be assigned a second order number starting with the dialogue closest to the top in the vertical direction within the each cut image 10 and closest to the left or the right at the same location in the vertical direction,

Also, each line of the text extracted for each detected dialogue area may be assigned as the row information a third order number starting with the line closest to the top in the vertical direction.

The text information 50 may include, as the order information, the first order number, the second order number, and the third order number for the text extracted from each dialogue area. For example, as described above with reference to FIG. 1, the text information 50 may include a cut number of the cut (first order number) including the extracted text, a number of the dialogue area (second order number), and a number of each line of the text (third order number).

In this regard, FIG. 12 illustrates an example of a method of determining the order of the cuts of content and a dialogue area included in each cut according to at least one example embodiment.

FIG. 12 illustrates an example of assigning an order number to each of the cuts and dialogue areas included in an image 1200 of webcomic content as order information.

Referring to FIG. 12, the closer to the top or to the left, a higher number (C1->C5) (first order number) may be assigned to a cut. Likewise, the closer to the top or to the left, a higher dialogue area number (0->6) (second order number) may be assigned. A dialogue area number may be assigned to a speech bubble identified as a dialogue area, but it may also be assigned to a dialogue area not classified into a speech bubble (see number 6 dialogue area). Here, the computer system 100 may generate a virtual speech bubble corresponding to the dialogue area classified into the speech bubble and may assign a dialogue area number (6) to the virtual speech bubble.

Further, unlike the illustrated example, the dialogue area number or numbers may be assigned within each cut independently of other cuts, and not continuously through all the cuts as in FIG. 12, depending on example embodiments.

Also, unlike the illustrated example, the closer to the top or the right, the higher cut number (first order number) may be assigned. Likewise, the closer to the top or to the right, the higher dialogue area number (second order number) may be assigned. The dialogue area number may be assigned to a speech bubble identified as a dialogue area.

That is, the direction of reading of content (e.g., book, comics, writing, etc.) may differ for each country or culture area, and the aforementioned first order number and second order number may be determined based on the direction of reading the content in the corresponding country or culture area.

Order information to be included in the finally generated text information 50 may be determined according to order information related to the cuts and the dialogue areas as illustrated in FIG. 12.

As described above with reference to operations 410 to 430, in an example embodiment, the computer system 100 may initially detect a cut in the image 10 through object detection and may detect a dialogue area in a cut image including the detected cut, without immediately extracting text from the image 10 and then may extract text from the dialogue area for each dialogue area using OCR.

Therefore, in an example embodiment, unnecessary text that does not correspond to ‘dialogue’ may not be extracted from the image 10 and the accuracy of the order of the dialogue of the extracted text may be guaranteed.

Description related to technical features made above with reference to FIGS. 1 to 3, FIG. 8, and FIGS. 14 to 16 may apply as is to FIG. 4, FIG. 7, and FIGS. 10 to 12 and thus, repeated description is omitted.

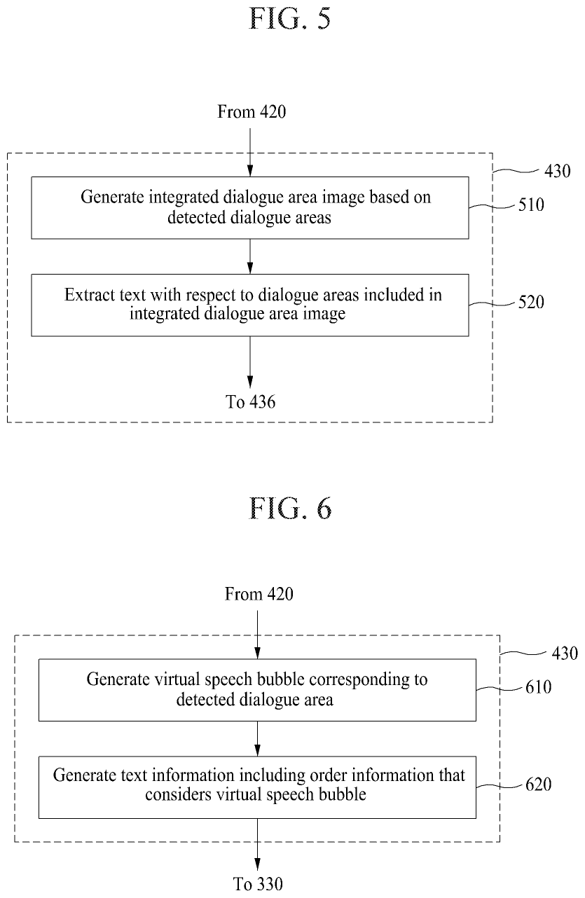

FIG. 5 is a flowchart illustrating an example of a method of generating an integrated dialogue area image by integrating dialogue areas extracted from cut image(s) and extracting text from the integrated dialogue area image according to at least one example embodiment.

A method of detecting a dialogue area in a cut image is further described with reference to FIG. 5.

In operation 510, the computer system 100 (or the processor 120) may generate a single integrated dialogue area image by integrating dialogue areas detected in cut images.

In operation 520, the computer system 100 (or the processor 120) may extract text included in each dialogue area for each dialogue area using OCR, with respect to dialogue areas included in the generated integrated dialogue area image.

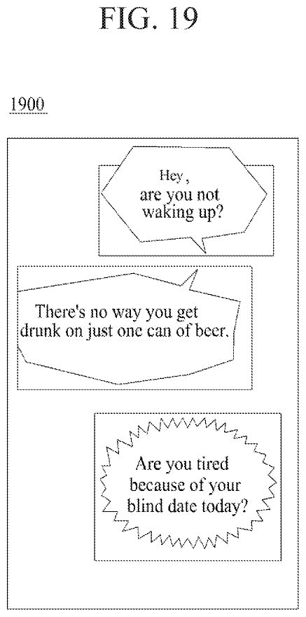

In this regard, FIG. 19 illustrates an example of an integrated dialogue area image according to at least one example embodiment.

Referring to FIG. 19, an integrated dialogue area image 1900 may include a plurality of dialogue areas (e.g., a plurality of speech bubbles). For example, the computer system 100 may generate a single integrated dialogue area image 1900 by integrating dialogue areas detected in a plurality of cut images. Depending on example embodiments, the computer system 100 may generate the integrated dialogue area image 1900 by integrating dialogue areas detected in a single cut image. The integrated dialogue area image 1900 may include an area including not a dialogue area but an object and only dialogue areas excluding a blank area, from a cut image. For example, the computer system 100 may mask a dialogue area (speech bubble, etc.) in a cut image and may generate the integrated dialogue area image 1900 by cropping and integrating an image corresponding to the masked dialogue area. Therefore, text included in each corresponding dialogue area may be extracted using OCR for each dialogue area included in the dialogue area image 1900 that is one image. Accordingly, in a task of extracting text included in each dialogue area for each dialogue area, the text included in each dialogue area may be extracted through processing only a smaller number of dialogue area images 1900 without the need to process a large number of images. Accordingly, network resources used for image processing and resources used for text extraction may be minimized. For example, extracting text from the dialogue area by reconstructing the detected dialogue area as the dialogue area image 1900 may improve the processing speed by about 11 times compared to extracting the text from the dialogue area by processing each cut image without reconstructing the detected dialogue area as the dialogue area image 190 (i.e., general serial processing).

In another example embodiment, the computer system 100 may perform recognition of a dialogue area (speech bubble, etc.) in a cut image and text extraction for each dialogue area in parallel. That is, the computer system 100 may perform an object detection task of recognizing the dialogue area (speech bubble, etc.) and a character recognition task of extracting text from each dialogue area in parallel. For example, the computer system 100 may detect a dialogue area in a cut image, may extract text from the detected dialogue area, and may detect another dialogue area while extracting the text from the detected dialogue area. Performing dialogue area detection processing and text extraction processing in parallel may improve the task speed compared to performing the dialogue area detection processing and text extraction processing in series. For example, such parallel processing may improve the task speed by 2 to 5 times compared to serial processing.

Here, in the above parallel processing, text extraction (recognition) uses more time than detection of a dialogue area and accordingly, a bottleneck may occur in the text extraction. Therefore, the parallel processing may make the task speed slower compared to extracting the text from the dialogue area by reconstructing the dialogue area as the dialogue area image 1900. That is, the amount of time required for the text extraction may be reduced by reconstructing the detected dialogue area as the dialogue area image 1900 and by extracting the text from the dialogue area.

Description related to technical features made above with reference to FIGS. 1 to 4, FIG. 7, FIG. 8, FIGS. 10 to 12, and FIGS. 14 to 16 may apply as is to FIGS. 5 and 19 and thus, repeated description is omitted.

FIG. 6 is a flowchart illustrating an example of a method of generating text information including extracted text and order information associated with the extracted text according to at least one example embodiment.

As described above with reference to FIG. 4 and FIG. 11B, in operation 610, in a case in which the detected dialogue area is a dialogue area that corresponds to the first area including the monologue or the narration or the second area including the explanatory text of the content, the computer system 100 (or the processor 120) may generate the virtual speech bubble 1130 corresponding to the first area or the second area. The virtual speech bubble 1130 may be generated to assign order information for the dialogue area.

In operation 620, the computer system 100 (or the processor 120) may generate the text information 50 including the order information that considers the generated virtual speech bubble. That is, the order information included in the text information 50 may include information regarding from which of speech bubbles text extracted for each detected dialogue area is extracted based on the order within the image 10 of speech bubbles that include a speech bubble corresponding to the detected dialogue area and the virtual speech bubble. That is, an order number of a dialogue area included in the order information may be sequentially assigned without distinction to all of a dialogue area classified into a speech bubble and a dialogue area not classified into a speech bubble.

Description related to technical features made above with reference to FIGS. 1 to 5, FIG. 7, FIG. 8, FIGS. 10 to 12, FIGS. 14 to 16, and FIG. 19 may apply as is to FIG. 6 and thus, repeated description is omitted.

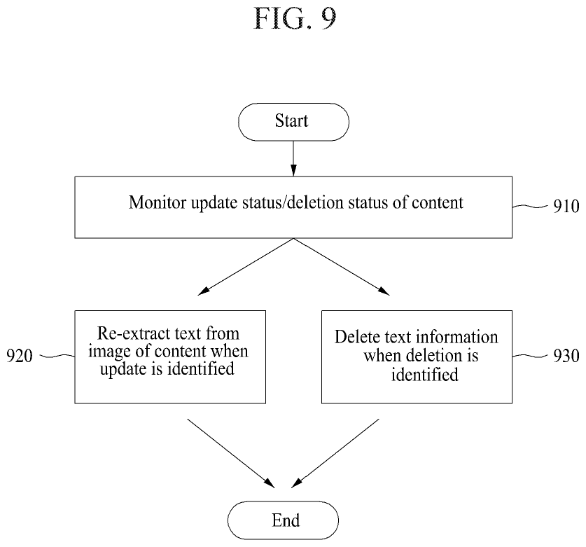

FIG. 9 is a flowchart illustrating an example of a method of generating text information or deleting the text information by re-extracting text according to update or deletion of content according to at least one example embodiment.

Content may be, for example, content that a consumer may view, such as webcomic content. This content may be uploaded to the content server 150 and then serviced to the consumer.

The content may be updated by deleting, modifying, or adding at least a portion of the content by an author of the content or an administrator of the content. When the content is updated, the updated content may be uploaded to the content server 150.

In operation 910, the computer system 100 or the processor 120 may monitor an update status and a deletion status of the content for the content server 150. For example, the computer system 100 may monitor the content server 150 periodically (e.g., every 1 hour) and accordingly, may identify updates and/or deletions of content already uploaded to the content server 150. Alternatively, the computer system 100 may receive a notification from the content server 150 that the content has been uploaded and/or deleted and accordingly, may identify the update status and the deletion status of the content.

In operation 920, when an update of the content is identified, the computer system 100 or the processor 120 may extract text from an image included in the updated content. That is, the computer system 100 may re-identify the updated content as content that is a subject to text extraction, may re-extract the text from the image of the updated content, and may regenerate text information including the re-extracted text. Depending on example embodiments, the computer system 100 may also identify an updated part of the content and text re-extraction may be performed only for the identified updated part.

In operation 930, when a deletion of the content is identified, the computer system 100 or the processor 120 may delete the text information 50 associated with the content.

In one embodiment, operations 920 and 930 may be performed only when the third function 1450 for setting an update availability status of the text information 50 is set to be OFF. That is, when the third function 1450 is set to be ON, update of the already registered text information 50 may be prohibited. Therefore, although the content is updated or deleted, the computer system 100 may not modify or delete the text information 50.

As described above, in an example embodiment, since text information is regenerated or deleted in consideration of updates and/or deletions of the content in the content server 150, the text information may quickly apply updates and/or deletions of the content.

Description related to technical features made above with reference to FIGS. 1 to 8, FIGS. 10 to 12, FIGS. 14 to 16, and FIG. 19 may apply as is to FIG. 9 and thus, repeated description is omitted.

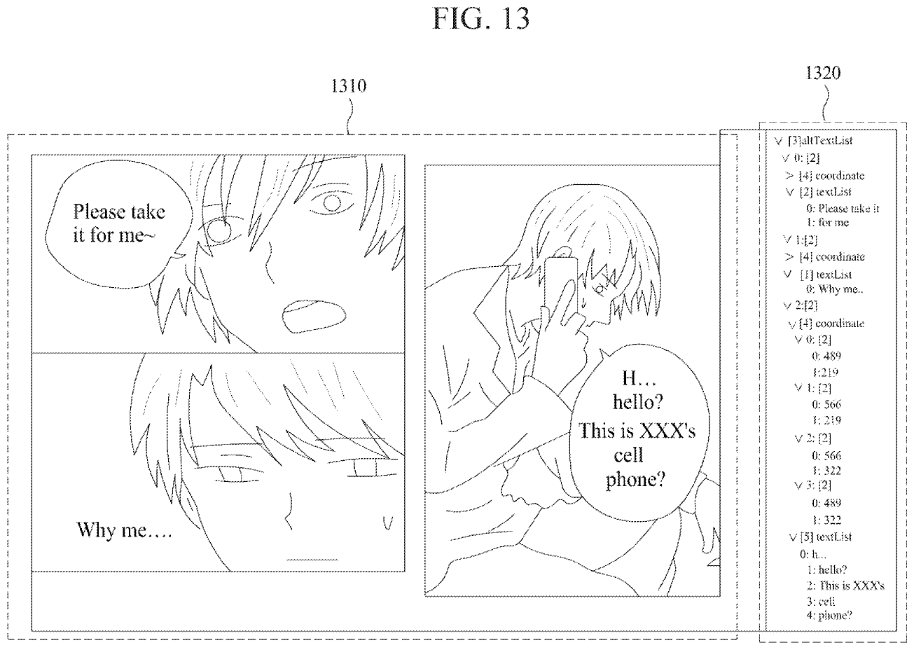

FIG. 13 illustrates an example of a method of providing text information according to at least one example embodiment.

FIG. 13 illustrates text information 1320 including cut images (or cuts) 1310 extracted from an image of content that is a subject to text extraction and text extracted from the cut images 1310.

The computer system 100 may detect dialogue areas of the cut images 1310 and may extract text included in each dialogue area.

The computer system 100 may generate the text information 1320 including the extracted text and order information on the corresponding text. The text information 1320 may also be referred to as alternative text.

The text information 1320 may include cut information (cut number) to which the extracted text belongs, dialogue area information (dialogue area number) to which the extracted text belongs, and row information (row number) of each line of the extracted text.

Referring to FIG. 13, the text information 1320 may be configured to be unfolded in response to the selection of the symbol ‘>’ by the user. The text information 1320 may further include location information (coordinates) within a cut or within an image including the cut. The location information may include at least one of the location of the cut (i.e., a location of a cut line), the location of the dialogue area (speech bubble, etc.), and the location of each line of text included in the dialogue area. The location information may be used as information to determine order information included in the aforementioned text information. For example, the order of a cut, the order of a dialogue area, or the order of each line of text included in the dialogue area may be determined according to coordinates represented by the location information. A text list may display a row number of each line of the text included in the dialogue area. The number of the dialogue area and/or the number of the cut may be displayed above the row number. Through the row number, whether text within the dialogue area has a line break may be identified.

That is, the ordering of the cut, the dialogue area and the text where ‘cut->dialogue area->text (each line of text) included in dialogue area’ may be displayed in the text information 1320 to have a hierarchical relationship. The text information 1320 may be used as meta information to provide the aforementioned audio information to the consumer of the content.

Description related to technical features made above with reference to FIGS. 1 to 12, FIGS. 14 to 16, and FIG. 19 may apply as is to FIG. 13 and thus, repeated description is omitted.

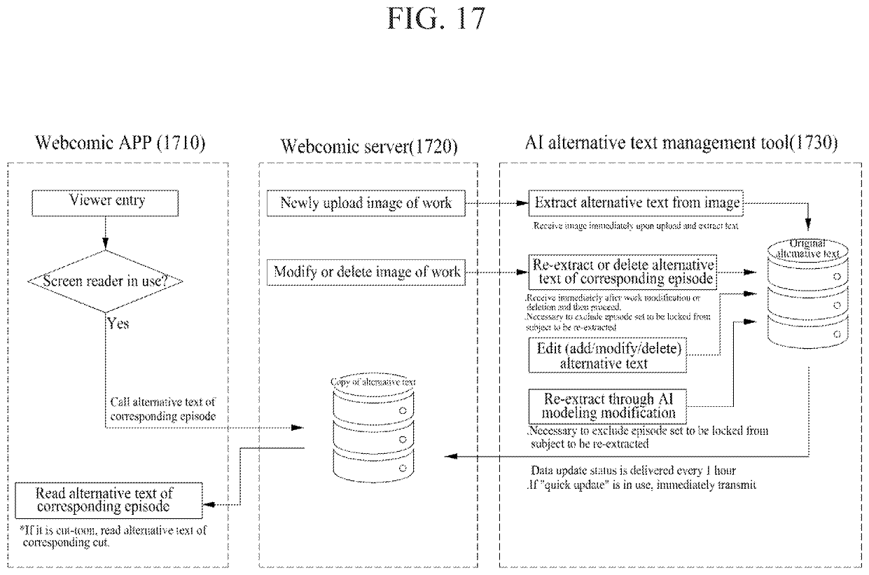

FIG. 17 illustrates an example of a method of extracting text from an image of content that is webcomic content and providing text information including the extracted text according to at least one example embodiment.

An example operation of a webcomic application (APP) 1710 executed on the consumer terminal 160 of the consumer, a webcomic server 1720 corresponding to the content server 150, and a text information management tool 1730 (AI alternative text management tool illustrated in FIG. 17) executed on the computer system 100 of an example embodiment (or administrator terminal) when the content is webcomic content is further described with reference to FIG. 17. The ‘text information’ is illustrated as alternative text in FIG. 17.

Referring to FIG. 17, on the side of the webcomic application 1710, the webcomic application 1710 may execute a viewer of content in response to a request from a consumer to view the content. Here, when the aforementioned ‘reader function (screen reader)’ is used on the webcomic application 1710, the webcomic application 1710 may request the content server 150 for alternative text that is text information associated with the content. Therefore, audio information corresponding to the alternative text may be provided from the content server 150 to the webcomic application 1710 and accordingly, a reading service of the alternative text may be provided to the webcomic application 1710. When the content is a webcomic with separate cuts, audio information corresponding to alternative text of a cut being viewed on the webcomic application 1710 may be provided to the webcomic application 1710.

The webcomic server 1720 may store a copy of the alternative text to provide a service to the webcomic application 1710. The copy of the alternative text may be provided from the text information management tool 1730.

Content including an image may be uploaded to the webcomic server 1720, and the text information management tool 1730 may identify the content as content that is subject to text extraction and may generate the alternative text by extracting the text from the image of the content.

Modification (update) or deletion of the content may be performed in the webcomic server 1720, and the text information management tool 1730 may recognize this update or deletion and may regenerate or delete the alternative text for the corresponding content. The modification (update) or deletion of the content may be immediately or periodically transmitted from the webcomic server 1720 to the text information management tool 1730. As described above, if a lock is set for the alternative text, the aforementioned regeneration or deletion of the alternative text may not be performed.

When AI modeling needs to be modified (e.g., the aforementioned learning model needs to be updated), the text information management tool 1730 may regenerate alternative text for the content. Even in this case, when the alternative text is set to be locked, the aforementioned regeneration of the alternative text may not be performed.

The text information management tool 1730 may provide a function of editing (adding/modifying/deleting) alternative text as a function of inspecting the generated alternative text. Accordingly, inaccuracy of generation of alternative text by an AI model may be corrected by the administrator.

Original alternative text may be stored in the computer system 100 including the text information management tool 1730 and the alternative text may be transmitted to the webcomic server 1720 periodically (e.g., every 1 hour). Here, when the UI 1570 for applying the text information to the service more quickly (e.g., with top priority) described above with reference to FIG. 15 is selected, the (inspected) alternative text may be immediately transmitted to the webcomic server 1720.

Description related to technical features made above with reference to FIGS. 1 to 16 and FIG. 19 may apply as is to FIG. 17 and thus, repeated description is omitted.

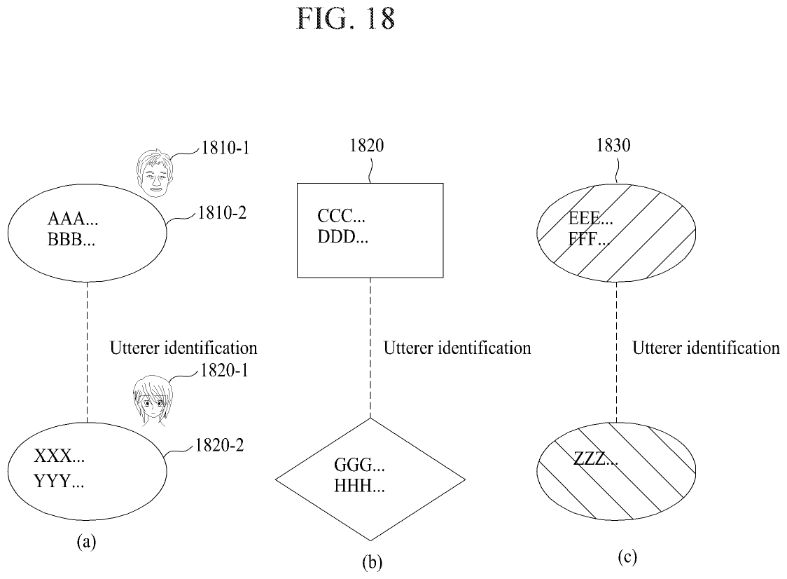

FIG. 18 illustrates an example of a method of determining an utterer or a character that utters text included in a dialogue area according to at least one example embodiment.

The computer system 100 may determine an utterer of content that utters text extracted for each detected dialogue area. The utterer may be a person appearing in the content or a character included in the content.

The computer system 100 may determine the utterer of the content using, for example, the aforementioned learning model. The learning model may be pretrained using a plurality of webcomic images and may be pretrained to estimate who uttered text of a dialogue area, such as a speech bubble, included in a corresponding webcomic image.

For example, as in the illustrated example, the computer system 100 may determine the utterer based on at least one of the utterer image represented in association with a speech bubble corresponding to the dialogue area detected in the image 10 of the content and the color or the shape of the speech bubble corresponding to the detected dialogue area.

For example, an image 1810-1, 1820-1 representing an utterer may be displayed around a speech bubble or a dialogue area and accordingly, the computer system 100 may determine from whom each of dialogue areas 1810-2 and 1820-2 originates, that is, is uttered. Alternatively, a speech bubble corresponding to a dialogue area may have a different shape depending on an utterer and the computer system 100 may determine from whom each of dialogue areas 1820 originates based on the shape of the speech bubble. Alternatively, the computer system 100 may determine from whom each of the dialogue areas 1820 originates based on the pointed direction of the tail of the speech bubble. Alternatively, a speech bubble corresponding to a dialogue area may have a different color depending on the utterer and the computer system 100 may determine from whom each of dialogue areas 1830 originates based on the color of the speech bubble.

In an example embodiment, the text information 50 generated based on text extracted for each detected dialogue area may further include information on the determined utterer. Therefore, the text information 50 may further include information regarding from whom the corresponding text originates, that is, uttered as well as order information of the text extracted from the content.

Description related to technical features made above with reference to FIGS. 1 to 17 and FIG. 19 may apply as is to FIG. 18 and thus, repeated description is omitted.

The apparatuses described herein may be implemented using hardware components, software components, and/or combination of the hardware components and the software components. For example, the apparatuses and the components described herein may be implemented using one or more processing devices, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to be performed through various computer methods. Here, the media may continuously store a computer-executable program or may temporarily store the same for execution or download. Also, the media may be various recording devices or storage devices in which a single piece of hardware or a plurality of hardware is combined and may be distributed over a network without being limited to media directly connected to a computer system. Examples of non-transitory computer-readable media include magnetic media such as hard disks, floppy disks, and magnetic tapes; optical media such as CD ROM disks and DVDs; magneto-optical media such as floptical disks; and hardware devices that are specially designed to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of providing text information associated with content, performed by a computer system, the method comprising:
identifying content including an image uploaded to a content server;
extracting text from the image included in the content; and
providing text information including the extracted text as the text information associated with the content.

2. The method of claim 1, wherein the image includes a plurality of cuts of the content in order and text including a dialogue of the content,
the extracted text is the dialogue extracted from the text included in the image, and
the text information includes each line of a plurality of lines included in the dialogue and order information of each line.

3. The method of claim 2, wherein the extracting of the text comprises:
detecting the plurality of cuts in the image;
generating each cut image including each cut of the plurality of cuts; and
extracting text from cut images corresponding to the plurality of cuts.

4. The method of claim 3, wherein the plurality of cuts are included in the image in vertically scrolling order, and
the each cut image is configured to further include a blank area of a predetermined size above and below the each cut.

5. The method of claim 3, wherein the extracting of the text from the cut images comprises:
detecting a dialogue area including the dialogue for the each cut image;
extracting text included in the dialogue area for each detected dialogue area using optical character recognition (OCR); and
generating the text information based on the text extracted for each detected dialogue area,
wherein the dialogue area is an area including a speech bubble included in the image, an area including monologue or narration by an utterer or a character of the content, or an area including explanatory text of the content, and
the text information includes, as the order information, information regarding from which dialogue area and from which cut the text extracted for each detected dialogue area is extracted.

6. The method of claim 5, wherein the order information further includes row information in a corresponding dialogue area of the text extracted for each detected dialogue area.

7. The method of claim 6, wherein each of the plurality of cuts is assigned a first order number starting with a cut closest to the top in a vertical direction within the image and closest to the left or the right at the same location in the vertical direction,
each dialogue area detected in the each cut image is assigned a second order number starting with a dialogue closest to the top in the vertical direction within the each cut image and closest to the left or the right at the same location in the vertical direction,
each line of the text extracted for each detected dialogue area is assigned as the row information a third order number that is starting with a line closest to the top in the vertical direction, and
the text information includes, as the order information, the first order number, the second order number, and the third order number for the text extracted from the each dialogue area.

8. The method of claim 5, wherein the extracting of the text from the cut images further comprises:
generating a virtual speech bubble corresponding to a first area or a second area when the detected dialogue area is the first area that includes the monologue or the narration or the second area that includes the explanatory text,
wherein the order information includes information regarding from which speech bubble the text extracted for each detected dialogue area is extracted among speech bubbles based on a speech bubble corresponding to the detected dialogue area and order within the image of the speech bubbles including the virtual speech bubble.

9. The method of claim 5, wherein the extracting of the text from the cut images further comprises:
generating a single integrated dialogue area image by integrating dialogue areas detected in the cut images; and
extracting text included in a corresponding dialogue area using OCR for each dialogue area, for the dialogue areas included in the integrated dialogue area image.

10. The method of claim 5, wherein the detecting of the dialogue area comprises:
detecting areas including text in the each cut image;
identifying, from among the areas, a non-dialogue area that is an area including text corresponding to background of the each cut, text representing sound effect of the content, and text determined to be unrelated to a story in the content; and
detecting areas excluding the non-dialogue area among the areas as the dialogue area including the dialogue.

11. The method of claim 2, wherein the providing of the text information comprises providing the text information to an administrator terminal in response to a request from the administrator terminal that manages the content, and further comprises providing a function that enables inspection of the text information for the administrator terminal, and
the function that enables the inspection includes at least one of a first function capable of editing the text information, a second function capable of downloading the text information, and a third function for setting an update availability status of the text information.

12. The method of claim 11, wherein the function that enables the inspection includes the first function, and
the providing of the function that enables the inspection comprises:
displaying the text information that includes a first cut selected by the administrator from among the plurality of cuts and dialogue extracted from the selected first cut on the administrator terminal;
providing a first user interface for editing the displayed text information; and
providing a second user interface for transition from the first cut to a second cut that is another cut among the plurality of cuts.

13. The method of claim 2, wherein the providing of the text information comprises providing audio information corresponding to the text information to a consumer terminal in response to a request from the consumer terminal that consumes the content.

14. The method of claim 13, wherein the providing of the text information comprises:
calling the text information associated with the content in response to a request from the consumer terminal for viewing the content;
recognizing a cut that is being viewed by the consumer terminal among the plurality of cuts; and
outputting audio information corresponding to a part corresponding to the recognized cut in the text information using the consumer terminal.

15. The method of claim 1, further comprising:
monitoring an update status and a deletion status of the content for the content server;
extracting text from the image included in the updated content when an update of the content is identified; and
deleting the text information associated with the content when a deletion of the content is identified.

16. The method of claim 5, further comprising:
determining an utterer of the content that utters the text extracted for each detected dialogue area, the utterer being determined based on at least one of an utterer image represented in association with a speech bubble corresponding to the detected dialogue area in the image and a color or a shape of the speech bubble corresponding to the detected dialogue area,
wherein the text information generated based on the text extracted for each detected dialogue area further includes information on the determined utterer.

17. A non-transitory computer-readable recording medium storing instructions that, when executed by a processor, cause the processor to perform the method of claim 1 on the computer system.

18. A computer system for providing text information associated with content, the computer system comprising:
at least one processor configured to execute instructions readable by the computer system,
wherein the at least one processor is configured to identify content including an image uploaded to a content server, to extract text from the image included in the content, and to provide text information including the extracted text as the text information associated with the content.

19. The computer system of claim 18, wherein the image includes a plurality of cuts of the content in order and text including a dialogue of the content,
the extracted text is the dialogue extracted from the text included in the image, and
the text information includes each line of a plurality of lines included in the dialogue and order information of each line, and
the at least one processor is configured to,
detect the plurality of cuts in the image, generate each cut image including each cut of the plurality of cuts, and extract text from cut images corresponding to the plurality of cuts, and
detect a dialogue area including the dialogue for the each cut image, extract text included in the dialogue area for each detected dialogue area using optical character recognition (OCR), and generate the text information based on the text extracted for each detected dialogue area,
wherein the dialogue area is an area including a speech bubble included in the image, an area including monologue or narration by an utterer or a character of the content, or an area including explanatory text of the content, and
the text information includes, as the order information, information regarding from which dialogue area and from which cut the text extracted for each detected dialogue area is extracted.
